(19) United States
(12) Patent Application Publication
(10) Pub. No.: US 2025/0338787 A1
(43) Pub. Date: Nov. 6, 2025

(54) AGRICULTURAL TOOL BAR SYSTEM

(71) Applicant: Ag Premier, Inc., Iowa Falls, IA (US)

(72) Inventors: Mick Zoske, Iowa Falls, IA (US); Calvin Carlson, Jewell, IA (US)

(21) Appl. No.: 19/272,691

(22) Filed: Jul. 17, 2025

Related U.S. Application Data
(63) Continuation of application No. 17/351,784, filed on Jun. 18, 2021.
(60) Provisional application No. 63/040,797, filed on Jun. 18, 2020.

(51) Int. Cl. A01B 73/04; A01B 63/32; A01B 73/00; A01B 73/06

(52) U.S. Cl. CPC A01B 73/044; A01B 63/32; A01B 73/005; A01B 73/06

(57) ABSTRACT

A tool bar system is provided that is configured and arranged with weight distribution that inhibits the tool bar system from applying lifting forces to the rear hitch of the tractor that is pulling the tool bar. In one or more embodiments, the toolbar system includes a frame, lift wheels, a tool mount bar assembly having one or more forward sections and one or more rearward sections. The rearward sections are positioned rearward of lift wheels. Forward sections are positioned closer to the front of the tool bar system than the rearward sections, thereby reducing lifting forces at the front end of the tool bar system.

### FIELD OF THE DISCLOSURE

This disclosure relates generally to farm implements and more specifically to agricultural tool bars.

### OVERVIEW OF THE DISCLOSURE

Agricultural tool bars are commonly utilized for deployment of various agricultural tools such as planters, cultivators, fertilizer applicators, irrigation systems and various other ground working implements to name a few. Tool bars generally include a frame supported by lift wheels or tracks and transverse bar attached thereto. Multiple agricultural tools (referred to as row units) are attached to and spaced along the horizonal bar to simultaneously perform operations (e.g., till, plant, and/or fertilize) on multiple rows of a field as the toolbar is pulled through the field. Some tool bars also include a swing pipe extending outward from a tower assembly mounted on the tool bar frame to an outer end upon which various agricultural tools may be attached (e.g., for spreading fertilizer, pesticides, and/or other treatments). The swing pipe is configured to pivot about the swing pipe tower to position the swing pipe to the sides, back or front for use or stowage.

In agriculture, the term “toolbar” is commonly used interchangeably to refer to both the horizontal bar to which row units are attached and also to refer to the entire tool bar apparatus that is pulled behind the tracker. As used herein, the term “tool bar” is used to refer to entire tool bar apparatus while “tool mount bar” or simply “mount bar” is used to refer to the horizonal bar to which row units are attached.

### SUMMARY OF THE DISCLOSURE

As farming operations have become larger, tractor pulling power, and the size of toolbars and other farming implements have increased. However, larger tool bars generally restrict maneuverability and make it more difficult to accurately navigate. For instance, if a planting area is on a slope, it can be extremely difficult to accurately navigate a desired path for planting and/or interplanting rows.

Through careful observation, it has been surprisingly discovered that weight distribution of current tool bars generates a lifting force at a rear hitch point of a pulling tractor, which can reduce traction of the rearward section of the tractor, thereby reducing maneuverability and control. This lifting force is particularly problematic when negotiating turns or operating on sloped areas. Additionally, reduced traction may cause unnecessary agitation and/or compaction of the soil, which may reduce yields.

Current tool bars that are on the market generally have one of two arrangements. In the first arrangement the swing pipe tower assembly and the tool mount bar are positioned rearward of the lift wheels of the tool bar. In the second arrangement to current tool bars, the tower assembly of the swing pipe is positioned forward of the lift wheels while the toolbar is positioned rearward of the lift wheels. In both of these arrangements, the tool bar frame and connection to the tool mount bar, and swing pipe tower assembly operate as a pivot or lever with lift wheels operating as a fulcrum. As a result, tool mount bar, row units attached to the tool mount bar, and swing pipe and tower assembly (if positioned rearward of the lift wheels) provide downward force on the rearward end of the tool bar which translates to upward force at a front end of the tool bar where the tool bar is connected to the tractor. The upward force at the front end of the tool bar is further increased when the swing pipe is positioned rearward behind the tool bar.

One or more example embodiments provide a tool bar system that is configured and arranged with weight distribution that inhibits the tool bar system from applying lifting forces to the rear hitch of the tractor that is pulling the tool bar. For example, in one or more embodiments, a toolbar system includes a frame, lift wheels, a tool mount bar assembly having one or more forward sections and one or more rearward sections. The rearward sections are positioned rearward of lift wheels. However, forward sections are positioned closer to the front of the tool bar system (e.g., in line with or forward of lift wheels), thereby reducing lifting forces at the front end of the tool bar system.

### BRIEF DESCRIPTION OF THE DRAWINGS

Example embodiments are described in detail below with reference to the attached drawing figures, wherein:

FIG. 1 is a top side view of a tool bar system having forward and rearward tool mount bar segments, in accordance with one or more embodiments of the present disclosure;

FIG. 2 is a left side view of the tool bar system shown in FIG. 1, in accordance with one or more embodiments of the present disclosure;

FIG. 3 is a right side view of the tool bar system shown in FIG. 1, in accordance with one or more embodiments of the present disclosure;

FIG. 4 is a front side view of the tool bar system shown in FIG. 1, in accordance with one or more embodiments of the present disclosure;

FIG. 5 is a back side view of the tool bar system shown in FIG. 1, in accordance with one or more embodiments of the present disclosure;

FIG. 6 is a right side view of a tool bar system having forward and rearward tool mount bar segments, in accordance with one or more embodiments of the present disclosure; and

FIG. 7 is a partial top side view of the tool bar system shown in FIG. 6, in accordance with one or more embodiments of the present disclosure.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of tool bars. However, the embodiments are not so limited. In is appreciated that the embodiments may be adapted for use in other agricultural implements and in other applications (e.g., involving heavy machinery), which may be improved by the disclosed structures, arrangements and/or methods. The system is merely shown and described as being used in in the context of tool bars for ease of description and as one of countless examples.

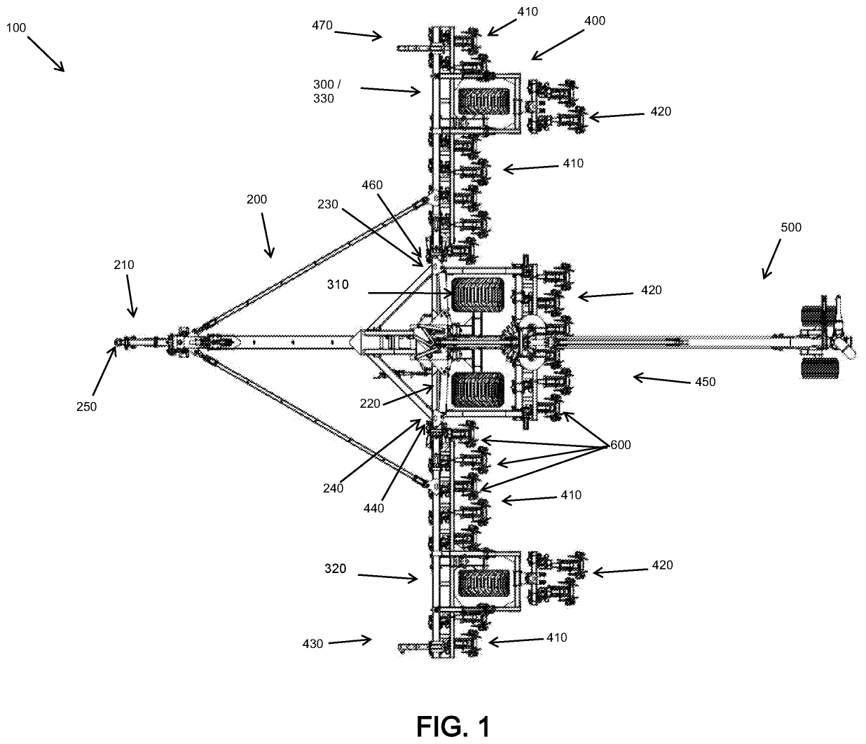

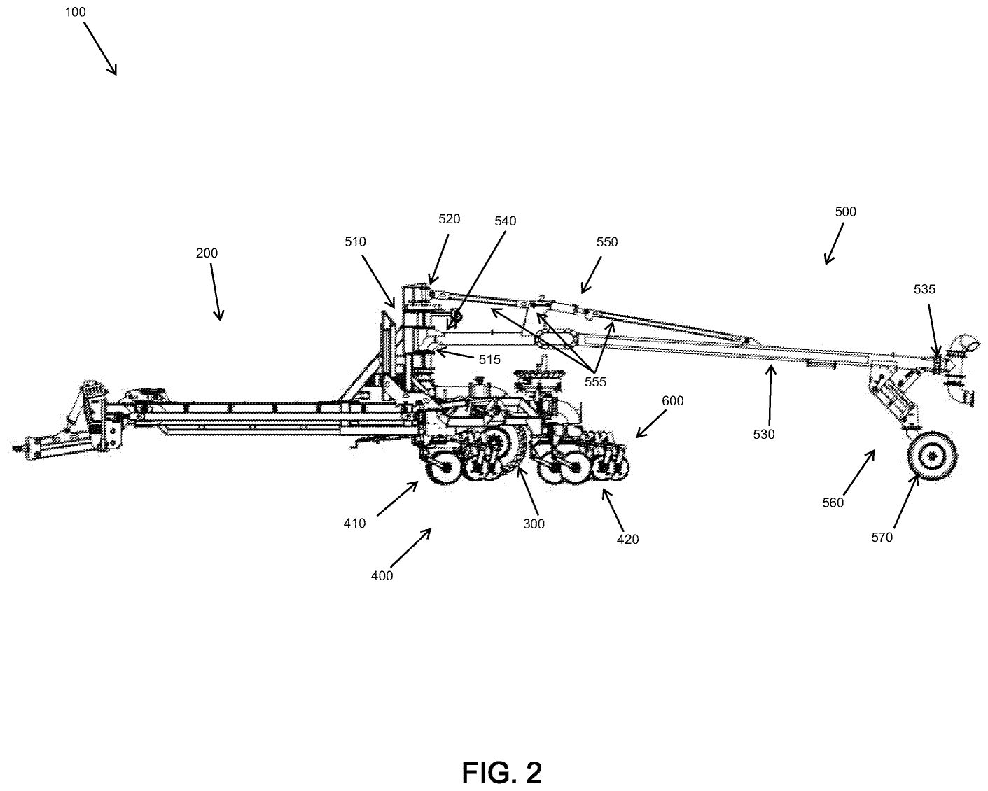

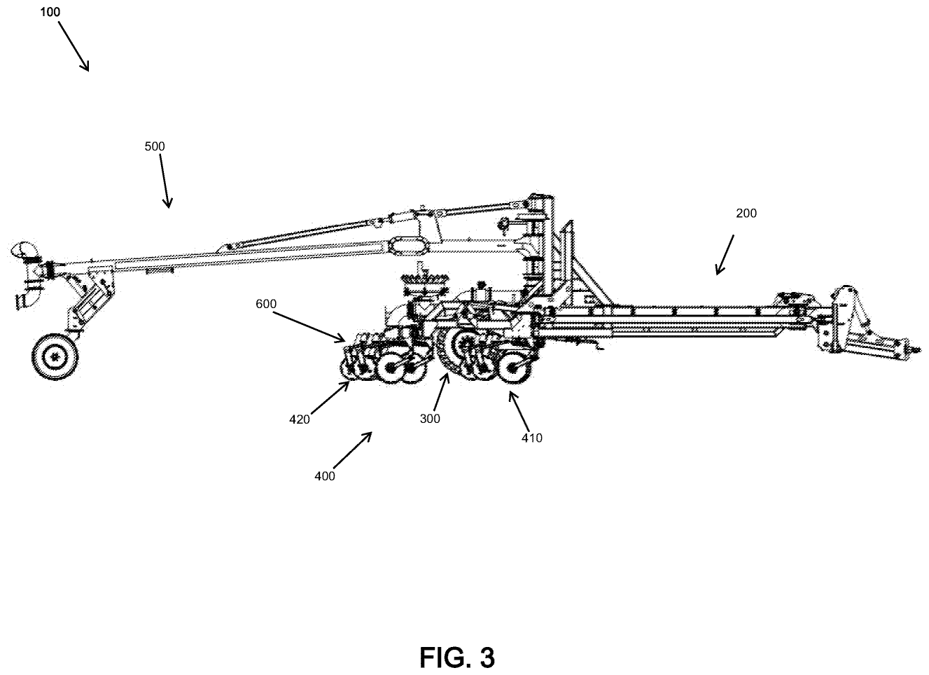

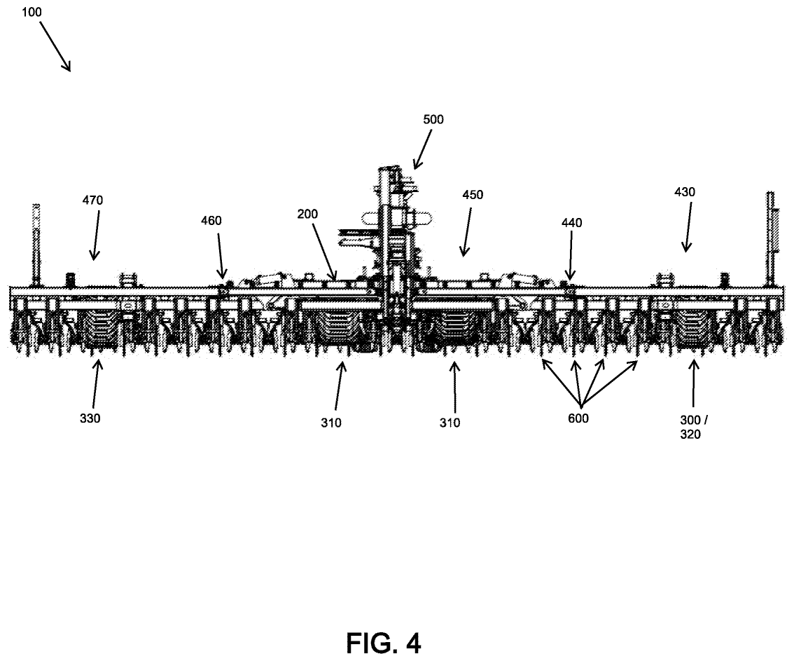

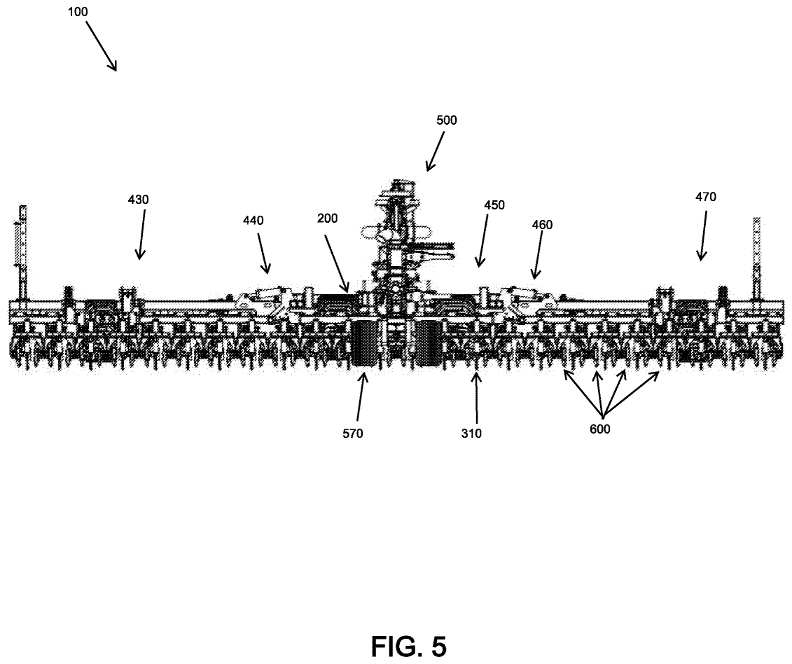

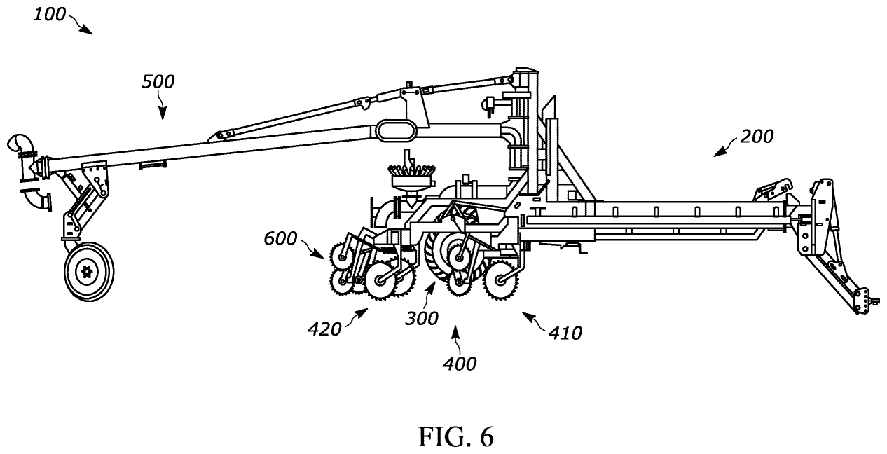

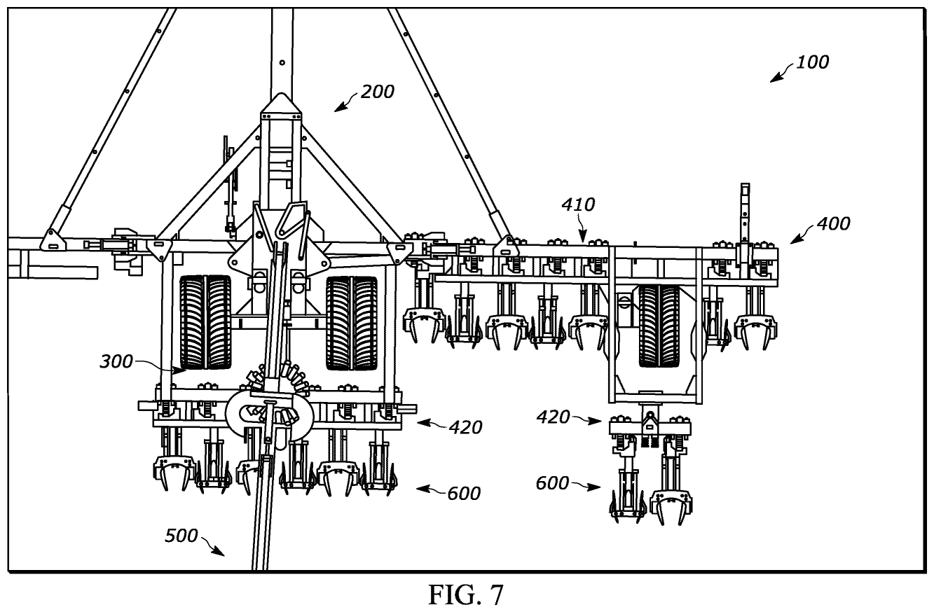

Turning now to the figures, FIGS. 1, 2, 3, 4 and 5 respectively show a top view and left, right, front, and back side view of an example tool bar system 100 (or simply system 100), in accordance with one or more embodiments. FIGS. 6 and 7 respectively show a right side and partial top side view of another example system 100, in accordance with one of more embodiments. Some components of the system 100 presented in FIGS. 6 and 7 are similar to components of the system 100 presented in FIGS. 1-5 and therefore all of the teaching presented herein with respect to FIGS. 1-5 applies equally to and is incorporated into the teaching presented in FIGS. 6-7 unless specifically stated otherwise.

### Tool Bar System 100

In various embodiments, the tool bar system 100 is configured to facilitate mounting of row units for use in the field. In the arrangement shown in FIGS. 1-5, the tool bar system 100 includes a frame 200, lift wheels 300, a tool mount bar assembly 400, a swing pipe assembly 500, and row units 600 among other components.

### Frame 200

In various embodiments, the frame 200 is configured to interconnect and support and lift wheels 300, tool mount bar assembly 400, and/or swing pipe assembly 500 and facilitate towing by a tractor. In the arrangement shown, as one example, frame 200 extends between a front end 210 and a rear end 220 and extends between a right side 230 and a left side 240. In this example arrangement, the frame 200 includes a connection member 250 at the front end 210 of the frame 200 for connecting tool bar system 100 to a tractor hitch.

### Lift Wheels 300

In one or more embodiments, system 100 includes a set of lift wheels 300 connected to frame 200 and configured to hold the frame 200 and/or tool mount bar assembly 400 above the ground when the front end 210 of the frame 200 is connected to a tractor. In various embodiments, the lift wheels 300 are configured to connect to the hold and support frame 200 at a suitable height for use in the field. In the arrangement shown, as one example, the set of lift wheels 300 include center wheels 310 operably connected to the rear end 220 of frame 200. In this example arrangement, lift wheels 300 also includes a left wheel 320 operably connected to a left section 430 of tool mount bar assembly 400 and includes a right wheel 330 operably connected to a right section 470 of tool mount bar assembly 400. While the arrangements are primarily shown with two center wheels 310, one left wheel 320, and one right wheel 330, the embodiments are not so limited. Rather, it is contemplated that system 100 may include more or fewer center wheels 310, left wheels 320, and/or right wheels 330 in some various embodiments. In one embodiment, the lift wheels 300 are generally arranged behind the rear 220 of the frame 200 so that the center of gravity of the frame 200 is between the rear 220 of the frame 200 and the connection member 250 of the frame. This may cause the connection member 250 to exert a downward force on a complementary connection member of a tractor pulling the tool bar system 1000 which may help stabilize the connection.

### Tool Mount Bar Assembly 400 and Row Units 600

In various embodiments, tool mount bar assembly 400 is configured to connect with and support row units 600 for use in the field. In the arrangement shown, as one example, tool mount bar assembly 400 includes a set of forward sections 410 and a set of rearward sections 420. In this example arrangement, rearward sections 420 are positioned behind lift wheels 300, while forward sections 410 are positioned closer to the front end 210 than the rearward sections 420. More specifically, in this example arrangement, forward sections 410 are positioned forward of lift wheels 300 and the rearward sections 420 are positioned rearward of lift wheels 300. By positioning forward sections 410 closer to the front end of the tool bar system 100, lifting forces on connection member 250 at the front end 210, where the system connects to a tractor, are reduced. In another embodiment, the lifting forces are entirely eliminated. And yet another embodiment, system 100 exerts a downward force on connection member. In this manner, traction, control, and/or maneuverability of the tool bar system 100 are improved in comparison to previous tool bars.

While the example arrangements are primarily depicted with forward sections 410 immediately in front of lift wheels 300. However, the embodiments are not so limited. Rather, in some embodiments, some or all forward sections 410 may be positioned further forward and/or further rearward (e.g., in line with lift wheels).

In this example arrangement, tool mount bar assembly 400 includes three rearward sections 420 in back of center wheels 310, left wheel 320, and right wheel 330. In this example arrangement, tool mount bar assembly 400 also includes four forward sections 410 to the side of left wheel 320, between left wheel 320 and center wheels 310, between center wheels 310 and right wheel 330, and to the side of right wheel 330. However, embodiments are not so limited. Rather, in some embodiments, tool mount bar assembly 400 may include more or fewer forward sections 410 and/or rearward sections 420 and/or may have forward sections 410 and/or rearward sections 420 positioned differently along the side to side width of the tool mount bar assembly 400.

Increasingly, farm implements have been designed to be folded between field-working and transport positions. In one or more embodiments, tool mount bar assembly 400 includes one or more hinged sections permitting the tool mount bar assembly 400 to be folded to facilitate easier storage and/or transport. In the arrangement shown, as one example, tool mount bar assembly 400, includes a left section 430, a center section 450, and a right section 470. The left section 430 is connected to a left side of the center section 450 by a first hinge member 440 and the right section 470 is connected to a right side of the center section 450 by a second hinge member 460. In various implementations, hinge members may be configured to fold left and right sections 430/470 upward in the air, forward to the front, and/or back to the rear. In some embodiments, the tool bar system 100 may be configured to fold and/or unfold the fold left and right sections 430/470 using hydraulics, gears, pullies, cables, and/or any other know mechanism used to facilitate movement of components in heavy machinery.

In one or more embodiments, forward sections 410 and rearward sections 420 of tool mount bar assembly 400 are configured to connect with and support various types of row units 600 for use in the field. Row units 600 may include but are not limited to, for example, planters, cultivators, fertilizer applicators, irrigation systems and various other ground working implements.

### Swing Pipe Assembly 500

In one or more embodiments, the tool bar system 100 includes a swing pipe assembly 500. In various arrangements, the swing pipe assembly 500 is configured to extend a swing pipe outward from the tool bar system. In the arrangement shown, as one example, swing pipe assembly 500 includes tower assembly 510, swing pipe 530, truss system 550, supports 555/560, and wheel 570, among other components.

In this example arrangement, the swing pipe 530 has a first end 535 (e.g., configured to attach to a drag hose) and a second end 540 attached to the tower assembly 510. The tower assembly 510 is mounted on and extends upward from frame 200. In the arrangement shown, as one example, the tower assembly 510 includes a cylindrical pipe supported by a plurality of legs. In one or more embodiment, the second end 540 of the swing pipe 530 is connected to the tower assembly 510 by a pivot member 515 configured to allow the swing pipe 530 to pivot vertically and/or horizontally about the tower assembly 510. In some example embodiments, the pivot member 515 may resemble a cylinder configured to rotate about a cylindrical portion of the tower assembly 510. In this manner, pivot member 515 may permit swing pipe to 530 to pivot in a horizontal plane.

In one or more embodiments, the swing pipe 530 may be comprised of a single pipe or a plurality of pipes. In the arrangement shown, as one example, the swing pipe 530 may be comprised of a plurality of pipe segments connected by a fitting. However, embodiments are not so limited. Rather, in some various embodiments, swing pipe 530, may be formed using more or fewer pipe segments. For example, the second pipe 244 may be replaced by rigid member, such as, an I-beam, channel iron, a rod, and/or other commercially available rigid members. Furthermore, there may be more than two pipes connected together to form the swing pipe 530.

In one or more embodiments, the first end 535 of the swing pipe 530 may be supported by a supporting member 560. In one or more embodiments, for example, the supporting member 560 may be a wheel 570, for example a castor wheel, in another embodiment, it may be a skid type structure. The supporting member 560 may take some load of the swing pipe 530 and of the manure flowing through the swing pipe 530. Thus, unlike traditional swing pipes which are supported in a cantilevered manner, the swing pipe 530 of example embodiments may be simply supported wherein the first end 535 of the swing pipe 530 is supported by a supporting member 560 and the second end 540 of the swing pipe 530 is supported by the tower assembly 510 of the tool bar system 100.

In one or more embodiments, the swing pipe assembly 500 may further include a truss system 550 configured to support and stabilize the swing pipe 530. In one embodiment, the truss system 550 includes a number of supports 555 which may be bars, pipes, tubes, I beams, H beams, or the like. The supports 555 are connected in a triangularized arrangement to provide rigid support for the swing pipe 530. The truss system 550 may be connected to the tower assembly 510 in a manner which is similar to the manner in which the swing pipe 530 is attached to the tower assembly 510 to permit the truss system 550 to pivot along with the swing pipe 530. For example, the truss system 550 may be connected to the tower assembly 510 by a second pivot me.

Example embodiments of the invention have been described in an illustrative manner. It is to be understood that the terminology that has been used is intended to be in the nature of words of description rather than of limitation. It will be appreciated by those skilled in the art that other various modifications could be made to the device without parting from the spirit and scope of this disclosure. All such modifications and changes fall within the scope of the claims and are intended to be covered thereby.

### SELECTED REFERENCE NUMBERS

Tool Bar System 100
Frame 200
Front End 210
Rear End 220
Right Side 230
Left Side 240
Connection Member 250
Lift Wheels 300
Center Wheels 310
Left Wheel 320
Right Wheel 330
Tool Mount Bar Assembly 400
Forward Sections 410
Rearward Sections 420
Left Section 430
Hinge Member 440
Center Section 450
Hinge Member 460
Right Section 470
Swing Pipe Assembly 500
Tower Assembly 510
Pivot Member 515
Pivot Member 520
Swing Pipe 530
First End 535
Second End 540
Truss System 550
Supports 555
Support Member 560
Wheel 570
Row Units 600

What is claimed:

1. A tool bar system, comprising:
a frame, the frame extending between a front end and a rear end and extending between a right side and a left side;
a set of wheels operably connected to the frame and configured to hold the frame off of the ground when the front end is connected to a tractor;
a tool mount bar assembly operably connected to the rear end of the frame, wherein the tool mount bar assembly includes one or more forward sections and one or more rearward sections;
wherein the one or more forward sections are positioned alongside or forward of the set of wheels; and
wherein the one or more rearward sections are positioned rearward of the set of wheels.

2. The system of one or more above claims, wherein the one or more forward sections are positioned in forward of the set of wheels.

3. The system of one or more above claims, wherein the one or more forward sections are positioned in line with the set of wheels.

4. The system of one or more above claims, wherein the frame includes a connection member for connection to a tractor hitch.

5. The system of one or more above claims, wherein the set of wheels include, a set of center wheels, a left wheel, and a right wheel.

6. The system of one or more above claims, wherein the tool mount bar assembly includes a left section, a center section, and a right section.

7. The system of one or more above claims, wherein the tool mount bar assembly includes:
a left section;
a center section;
a right section;
a first hinge member operably connecting the left section to the center section; and
a second hinge member operably connecting the right section to the center section.

8. The system of one or more above claims, further comprising a plurality of row units operably connected to the tool mount bar assembly.

9. The system of one or more above claims, further comprising a swing pipe assembly.

10. The system of one or more above claims, further comprising a swing pipe assembly having:
a tower assembly mounted on the frame;
a swing pipe having one end operably connected to the tower assembly and extending from the tower assembly to a second end; and
a support member operably connected to the second end of the swing pipe.

11. A tool bar system, comprising:
a frame, the frame extending between a front end and a rear end and extending between a right side and a left side;
a set of wheels operably connected to the frame and configured to hold the frame off of the ground when the front end is connected to a tractor;
a tool mount bar assembly operably connected to the rear end of the frame, wherein the tool mount bar assembly includes one or more forward sections and one or more rearward sections;
wherein the center of gravity of the tool bar system is between the set of wheels and the front end of the frame.
